(19) United States
(12) Patent Application Publication
(10) Pub. No.: US 2019/0181493 A1
(43) Pub. Date: Jun. 13, 2019

(54) Separator/Current Collector Unit for Galvanic Cells

(71) Applicant: Bayerische Motoren Werke Aktiengesellschaft, Muenchen (DE)

(72) Inventors: Christoph BAUER, Muenchen (DE); Simon LUX, Muenchen (DE); Hideki OGIHARA, Haimhausen (DE)

(21) Appl. No.: 16/281,494

(22) Filed: Feb. 21, 2019

Related U.S. Application Data
(63) Continuation of application No. PCT/EP2017/059875, filed on Apr. 26, 2017.

(30) Foreign Application Priority Data
Aug. 22, 2016 (DE) 10 2016 215 667.5

(51) Int. Cl. H01M 10/0525; H01M 10/0583; H01M 10/04; H01M 4/66; H01M 4/70; H01M 2/18; H01M 2/26; H01M 4/86

(52) U.S. Cl. CPC H01M 10/0525; H01M 10/0583; H01M 10/045; H01M 4/661; H01M 2220/20; H01M 2/18; H01M 2/26; H01M 4/8605; H01M 4/70

(57) ABSTRACT

A separator/current collector unit for a galvanic cell, in particular for a lithium-ion cell, is provided. The separator/current collector unit has a separator and a number N≥1 of electrically conductive current collectors, each of which is arranged on the surface of the separator and is connected to same in order to form a unit, in the process forming a respective boundary surface together with the surface of the separator. Each of the current collectors has a porous material for receiving an electrolyte such that the separator/current collector unit conducts ions through the at least one boundary surface when the porous material has received electrolytes. A galvanic cell is also provided having a separator/current collector unit. Also, a battery is provided made of multiple galvanic cells.

### CROSS REFERENCE TO RELATED APPLICATIONS

This application is a continuation of PCT International Application No. PCT/EP2017/059875, filed Apr. 26, 2017, which claims priority under 35 U.S.C. § 119 from German Patent Application No. 10 2016 215 667.5, filed Aug. 22, 2016, the entire disclosures of which are herein expressly incorporated by reference.

### BACKGROUND AND SUMMARY OF THE INVENTION

The present invention relates to a separator/current collector unit for galvanic cells, in particular for lithium-ion cells. The present invention also relates to a galvanic cell having such a separator/current collector unit, and a battery having a multiplicity of such galvanic cells.

Lithium-based galvanic cells and primarily batteries constructed therefrom, in particular lithium-ion accumulators, are used as electrical energy stores and suppliers in many electrical devices. The best-known applications in this context include lithium-ion accumulators for electric or hybrid vehicles and for what are known as consumer products. The latter include in particular mobile terminals, such as notebook computers, tablet computers, mobile telephones or cameras. A conventional lithium-based battery, in particular for electric or hybrid vehicles, has a multiplicity of individual galvanic cells that are stacked above one another and each have a negative and a positive electrode layer that are separated spatially and electrically from one another by a separator layer. The cells are generally connected to one another in parallel or in series so as to achieve the overall voltage or current delivery capability required for the battery. In this case, the cell stack may be oriented along a single stacking direction or wound in the form of what is known as an electrode winding. Prismatic or cylindrical battery housing shapes are accordingly often to be found, these enclosing the cell stack and also providing it with mechanical strength.

The individual electrodes of the cell stack in this case normally consist of a thin layer-type and mechanically loadable carrier substrate, which may in particular at the same time be electrically conductive and thus able to serve as collector substrate and/or current collector of the electrode, as well as an active material, usually in paste form, that is applied in the form of a layer to one side or both sides of the carrier substrate. What are known as “free-standing electrodes” or “FSEs” are also nowadays known, however, these being electrodes in which the carrier substrate is dispensed with since the active material itself has the necessary mechanical strength to be able to successfully withstand the mechanical loads that typically arise in the manufacture and during operation of the galvanic cells in the context of their design or specifications. Products and technologies that use such free-standing electrodes are currently being developed and in some cases marketed for example by “24M” and “Maxwell Technologies”. Free-standing electrodes for lithium-based galvanic cells and methods for the manufacture thereof are described in US 2015303481 A1.

In currently known lithium-based galvanic cells and batteries, the current collectors, which are necessary to supply or dissipate the electric current and are respectively electrically conductively connected to the electrode or electrodes of a particular polarity, are manufactured separately and have to be connected to the respective electrodes in the production of the cell or battery by way of suitable process steps before they are then combined together with a separator so as to form a cell. This also applies in the case of free-standing electrodes.

It is an object of the present invention to improve the achievable energy density of galvanic cells and batteries as well as the manufacturability thereof, in particular with respect to a reduction of the complexity and/or production times thereof.

This and other objects of the invention are achieved by a separator/current collector unit, a galvanic cell having such a separator/current collector unit, and a battery having a multiplicity of such galvanic cells in accordance with embodiments of the invention.

A first aspect of the invention relates to a separator/current collector unit for a galvanic cell, in particular for a lithium-ion cell. The separator/current collector unit has a separator and a number N≥1 of electrically conductive current collectors that are each arranged on the surface of the separator and connected thereto so as to form a unit, and in so doing form a respective interface with the surface of the separator. Each of the current collectors has a porous material for receiving an electrolyte, such that the separator/current collector unit has an ion-conducting action through each of the interfaces when the porous material has received the electrolyte.

As defined herein, a “separator/current collector unit” refers to a component, designed as a separate unit, for a galvanic cell and/or a battery consisting of a plurality of galvanic cells, this component has both a separator and at least one current collector connected thereto.

As defined herein, a “separator” refers to a component of a galvanic cell that is configured so as to spatially and electrically separate the negative and the positive electrode in the galvanic cell. The separator however has to be permeable to the ions, which are involved in the conversion of the chemical energy stored in the cell into electrical energy and in so doing have to be able to travel through the separator between the negative electrode and the positive electrode and vice versa. Liquid-impregnated microporous plastics and nonwovens made from fiberglass or polyethylene are primarily used as materials. In the case of lithium-ion cells in particular, separators in the form of liquid-impregnated microporous membranes are sometimes also used so as to enable the passage of ions. Such membranes are mostly polymer films that may also consist of several plies. Also known are heat-resistant microporous ceramic separators, primarily in liquid-impregnated or dry form. Materials based on a very thin nonwoven coated with ceramic are also known as separators, in particular for use in traction batteries for electric cars and hybrid vehicles.

As defined herein, a “current collector” refers to an electrically conductive structure of a galvanic cell or battery that is electrically conductively connected to one or a plurality of identical electrodes so as to dissipate electric current from these electrodes during operation of the cell or to supply said current to them.

In the present invention, the separator and one or more current collectors are advantageously configured together in the form of a component or a unit, and do not have to be processed separately in the manufacture of a galvanic cell. This may be utilized to reduce the complexity of the corresponding production process, in particular the number of corresponding process steps. Furthermore, each of the current collectors, since it is installed on a surface of the separator, is able to utilize the mechanical strength thereof and thus be configured so as to be thinner and with less material and therefore less bulk than would be the case with a free-standing current collector. In this way, it is thus also possible to increase the gravimetric energy density of galvanic cells. Finally, inversely, it is also possible to increase the mechanical strength and stability of the separator, usually configured in the form of a thin layer or membrane, through the connection thereof to the current collector or the current collectors, which in turn makes it possible to reduce the cycle time during production.

Preferred embodiments of the separator/current collector unit and developments thereof are described below, each of which are able to be combined with one another as desired and with the other aspects of the invention described further below, unless expressly stated otherwise.

According to a first preferred embodiment, the separator and each of the current collectors are each designed in the form of a layer and together form a layer stack. This gives a particularly space-saving arrangement of the separator and of the current collector or the current collectors, which is able to be combined particularly well with conventional structures of galvanic cells, since conventional separators are often likewise designed as a layer stack. According to one preferred embodiment, the separator/current collector unit is designed as a film containing the layer stack. This also provides the advantage that the separator/current collector unit may be flexible, which may be utilized to produce galvanic cells in which the separator needs to be flexible, in particular foldable (for example in the case of a cell structure using a “Z-fold”).

According to a further preferred embodiment, at least one of the current collectors is applied to the separator in the form of a physically or chemically deposited coating. In other embodiments, the coating may be applied using one or more of the following coating techniques: evaporation deposition, galvanic coating, physical vapor deposition (PVD) or chemical vapor deposition (CVD), liquid current-free coating or sputtering. This advantageously makes it possible to produce particularly thin current collector layers on the separator, which may be utilized to increase the energy density (in particular the gravimetric energy density) of galvanic cells.

According to a further preferred embodiment, it holds true that N≥2, the separator/current collector unit has a first and a second separate current collector, and the first and the second current collector are arranged on the separator such that the separator lies at least partly between the first and the second current collector. This makes it possible to provide in each case one or more current collectors on the separator, respectively both for a positive electrode and for a negative electrode of a galvanic cell. This allows a particularly space-saving structure, which is therefore advantageous in the context of increasing the energy density, of corresponding galvanic cells, since a separate current collector then does not have to be provided for either of the two types of electrode (which would in turn entail corresponding additional production steps). According to one embodiment, the first current collector contains copper or nickel. This is expedient in particular when the first current collector is intended for a negative electrode, in particular of a lithium-ion battery. According to another embodiment, preferably also combinable therewith, the second current collector contains aluminum or nickel. This is expedient in particular when the second current collector is intended for a positive electrode, in particular of a lithium-ion battery.

A second aspect of the invention relates to a galvanic cell, which may preferably be a lithium-ion cell. The cell has a first electrically negative electrode, a second electrically positive electrode and a separator/current collector unit, arranged between the two electrodes and in touching contact with each of them and is provided with an electrolyte, in accordance with the first aspect of the invention, and in accordance with one or more of its previously described preferred embodiments.

According to one preferred embodiment of the cell, it holds true that N≥2, the separator/current collector unit has a first and a second separate current collector, and the first and the second current collector are arranged on the separator such that the separator lies at least partly between the first and the second current collector. The first current collector contains copper or nickel and the second current collector contains aluminum or nickel. In this case, the first current collector is in touching contact with the first electrode and the second current collector is in touching contact with the second electrode. In this way, additional current collectors in the cell may be dispensed with since these are already provided in the separator/current collector unit and are in electrically conductive contact with the respective electrode. Accordingly, no additional process steps for inserting and connecting additional current collectors are necessary in the manufacture of such a cell, which accordingly reduces production complexity for the cell.

According to a further preferred embodiment, at least one of the electrodes is designed as a free-standing electrode, FSE. This is preferably true for all electrodes of one electrode type (positive or negative), particularly even for all of the electrodes of the cell. The complexity of the production of the cell is therefore able to be further reduced and its energy density is able to be further increased, since both additional current collectors and carrier substrates for creating the mechanical stability of the electrodes are able to be dispensed within the manufacture of the cell. Instead of this, it is enough to bring a respective positive and negative free-standing electrode into touching contact with the corresponding current collector of the separator/current collector unit, for instance by corresponding stacking, so as to create a galvanic cell.

A third aspect of the invention relates to a battery, in particular a lithium-ion battery. It has a cell stack that has a multiplicity of stacked galvanic cells in accordance with the second aspect of the invention, and in accordance with one or more of its embodiments described herein. The cell stack may be present in the form of a traditional stack having a plurality of individual layers stacked above one another along a single stacking direction or in the form of what is called a “Z-fold”, in which stacking is performed by way of Z-shaped folding of a permeable multilayer substrate that contains the electrodes and the separator/current collector unit. A design of the cell stack as an electrode winding, in which the multilayer substrate is present in wound form, is furthermore also possible in principle, as long as the corresponding electrode material and the separator/current collector unit have the flexibility required for this. The invention may be used to particular advantage in conjunction with typical time-intensive stacking or Z-folding processes to produce the battery, since, in particular in the transition from winding processes to one of these processes, due to the reduced number of battery components that is made possible according to the invention, the complexity of the production process is able to be reduced and therefore a significant increase in efficiency, in particular including a reduction in process times, is able to be achieved in the production of the battery.

According to one preferred embodiment of the battery, the separator/current collector units of the galvanic cells of the cell stack are each designed such that it holds true that N≥2 and the respective separator/current collector unit has a first and a second separate current collector. In this case, the first and the second current collector are each arranged on the corresponding separator such that the separator lies at least partly between the first and the second current collector. The first current collector contains copper or nickel, and the second current collector contains aluminum or nickel. In this case, the first current collector is in touching contact with the first electrode and the second current collector is in touching contact with the second electrode. Inside the cell stack, the separator/current collector units that are consecutive along the stacking direction of said cell stack have an alternating orientation, such that, for immediately consecutive separator/current collector units, the respective order of the arrangement of the current collectors and separators is inverted along the stacking direction. This provides a battery having reduced complexity and optimized energy density, in which the individual cells are stacked above one another along a stacking direction. In this case, a separator/current collector unit is provided in each of the cells between the associated electrodes. Due to the alternating orientation of the consecutive separator/current collector units, it is thus easy overall to create a series circuit of the individual cells of the battery.

According to a further preferred embodiment, at least one of the electrodes of the battery is designed as an integral electrode, which at the same time functions as an identical electrode of two adjacent cells of the galvanic cells in the cell stack. This again reduces the number of components of the battery. The thickness and/or bulk of the integral electrode may also be selected so as to be smaller than the sum of the thicknesses or bulks in the case of separate identical electrodes of the adjacent cells, without impacting their mechanical stability. It is thus possible to achieve a further increase in the energy density of the battery.

According to a further preferred embodiment of the battery, the galvanic cells are stacked by way of a Z-fold so as to form the cell stack. As already mentioned above, this allows a particularly high energy density of the battery and allows the cell stack to be produced from a single multilayer substrate.

The embodiments, developments and advantages respectively described above for the separator/current collector unit correspondingly apply equally to the galvanic cell according to the second aspect of the invention and the battery according to the third aspect of the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a separator/current collector unit having a single current collector, according to an embodiment of the invention.

FIG. 2 schematically shows a separator/current collector unit according to an embodiment of the invention, in which a current collector is provided in each case on two opposing sides of a separator.

FIG. 3 schematically shows a galvanic cell according to one embodiment of the invention, having a separator/current collector unit according to FIG. 2.

FIG. 4 shows a battery, in particular a lithium-ion battery according to one embodiment of the invention, which is constructed from a multiplicity of galvanic cells stacked above one another with integral electrodes of adjacent cells.

### DETAILED DESCRIPTION

The same reference signs are used throughout the following figures for the same or mutually corresponding elements of the invention.

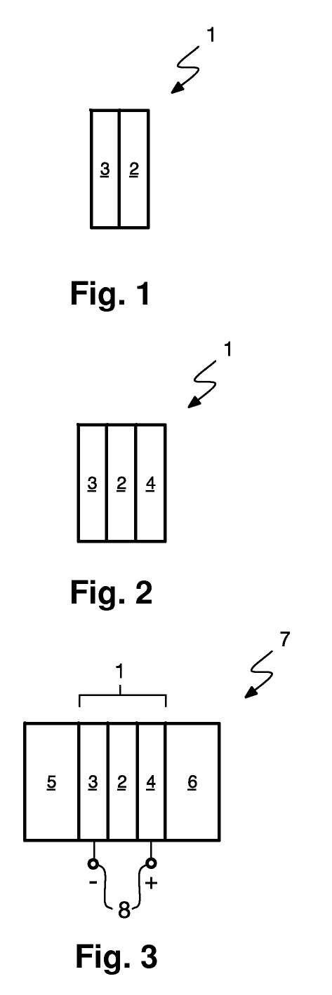

Reference is made first of all to FIG. 1, which schematically illustrates one embodiment of a separator/current collector unit 1 according to the invention. The separator/current collector unit 1 has a separator 2 which may be designed in the form of a microporous membrane made from plastic or ceramic. In this case, known commercially available separators, in particular those for lithium-ion batteries, may be used.

A current collector 3 in the form of a metal layer is applied, in particular vapor-deposited, onto a main surface of the separator 2. Depending on whether this current collector is intended to serve as a current collector for a negative or a positive electrode in the structure of a galvanic cell by way of the separator/worker unit 1, the material of the metal layer is selected accordingly. In particular, the use of copper or nickel is advantageous for a current collector of a positive electrode and the use of aluminum or nickel is advantageous for a current collector of a negative electrode. This applies in particular when the galvanic cell constitutes a lithium-ion cell. Each of the current collectors has a porous material for receiving an electrolyte, such that the separator/current collector unit has an ion-conducting action through the at least one interface when the porous material has received the electrolyte. The metal layer preferably has this porosity itself. The electrolytes known for conventional lithium-ion cells are primarily used as electrolyte here.

In a galvanic cell that is equipped with a separator/current collector unit 1 according to this first embodiment, it is possible to provide a current collector 3 only for one of the two electrodes of the cell by way of the separator/worker unit 1, whereas the other electrode is provided with an additional current collector or, on account of its specific structure, in particular in the case of a free-standing electrode, is able to dispense with one of these.

FIG. 2 shows a further development of the separator/current collector unit 1 from FIG. 1, in which a current collector 3 or 4 is in each case applied, preferably in the form of a layer, to both opposing main sides of the separator 2. In this case, it is expedient for a first of the two current collectors 3 and 4, for example the current collector 3, to consist of a material that is suitable as a current collector for a negative electrode from a chemical and in particular electrochemical point of view. The same applies to the other current collector, in the example the current collector 4, with regard to a positive electrode. In particular, the first current collector may contain or consist of copper or nickel, and the second current collector may contain or consist of aluminum or nickel. Each of the current collectors again has a porous material for receiving an electrolyte, such that the separator/current collector unit overall has an ion-conducting effect when the porous material has received the electrolyte.

FIG. 3 schematically illustrates a galvanic cell 7 that has a separator/current collector unit according to FIG. 2 that is filled with a suitable electrolyte. Especially in the case of a lithium-ion battery, the electrolyte may contain lithium ions. In addition, the cell 7 has a first electrode 5 that is in touching contact with the first current collector 3, and a second electrode 6 that is in touching contact with the second current collector 4. Due to the respective touching contact, each of the two electrodes 5 and 6 is also electrically conductively connected to the corresponding current collector 3 or 4, such that the respective current collector 3 or 4 is able to conduct currents from and to the respectively associated electrode 5 or 6. Each of the current collectors (3; 4) has a porous material for receiving the electrolyte, such that the separator/current collector unit 1 has an ion-conducting effect through the at least one interface.

The current collectors 3 and 4 may additionally have external terminals 8a or 8b. The terminals 8a or 8b may in particular serve to connect a plurality of cells 7 to one another so as to form a battery, and/or to provide the electric voltages or currents generated by the cell 7 to other electrical components.

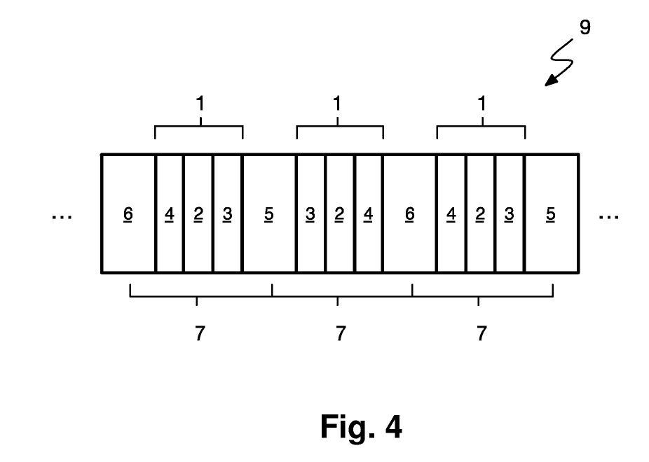

FIG. 4 schematically illustrates a battery 9, in particular a lithium-ion battery, which is constructed from a multiplicity of galvanic cells 7 stacked above one another along a stacking direction (this is the horizontal direction in the illustration of FIG. 4). In this case, the identical (that is to say positive or negative) electrodes 5 or 6, each facing one another due to the stacking, of respectively adjacent galvanic cells 7 are each combined so as to form an integral electrode 5 or 6 that at the same time functions as a corresponding electrode of the two adjacent galvanic cells 7. As an alternative, it is also possible to configure the corresponding identical electrodes 5 or 6 separately for each cell and to connect the identical electrodes 5 or 6, lying next to one another in the cell stack, to one another.

Each of the cells 7 has a separator/current collector unit 1 that is arranged between the two integral electrodes 5 or 6 of the cell 7 and is in touching contact and therefore also in electrical contact with the respective electrodes 5 or 6 by way of its current collectors 3 or 4. In this case, the order of the first current collector 3, of the separator 2 and of the second current collector 4 of the separator/current collector units 1 that are immediately consecutive along the stacking direction of the cells 7 alternates, such that each of the electrodes 5 or 6 is only surrounded by identical current collectors 3 or 4.

Although at least one exemplary embodiment has been described above, it should be noted that a large number of variations thereto exist. It should also be borne in mind in this case that the described exemplary embodiments merely constitute non-limiting examples, and it is not thereby intended to restrict the scope, the applicability or the configuration of the devices and methods described herein. Rather, the above description will give a person skilled in the art instructions for implementing at least one exemplary embodiment, it being understood that various changes in the function and the arrangement of the elements described in one exemplary embodiment may be made without in so doing deviating from the subject matter respectively defined in the appended claims and equivalents thereof.

### LIST OF REFERENCE SIGNS

1 separator/current collector unit
2 separator
3 first current collector, in particular for negative electrode
4 second current collector, in particular for positive electrode
5 first electrode, in particular negative electrode
6 second electrode, in particular positive electrode
7 galvanic cell
8a, b terminals of the galvanic cell
9 battery

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A separator and current collector unit for a galvanic cell, comprising:
a separator; and
a number N≥1 of electrically conductive current collectors, each of which is arranged on a surface of the separator and is connected thereto in order to form a unit, in the process forming a respective interface with the surface of the separator;
wherein each of the current collectors has a porous material for receiving an electrolyte, such that the separator and current collector unit conducts ions through each of the interfaces when the porous material has received the electrolyte.

2. The separator and current collector unit according to claim 1, wherein the galvanic cell is a lithium ion cell.

3. The separator and current collector unit according to claim 1, wherein the separator and each of the current collectors are each designed in the form of a layer and together form a layer stack.

4. The separator and current collector unit according to claim 3, wherein the separator and current collector unit is designed as a film containing the layer stack.

5. The separator and current collector unit according to claim 1, wherein at least one of the current collectors is applied to the separator in the form of a physically or chemically deposited coating.

6. The separator and current collector unit according to claim 5, wherein the coating is applied using one or more of the following coating techniques selected from the group consisting of: evaporation deposition, galvanic coating, physical or chemical vapor deposition, and sputtering.

7. The separator and current collector unit according to claim 1, wherein:
it holds true that N≥2;
the separator and current collector unit has a first and a second separate current collector, and
the first and the second current collector are arranged on the separator such that the separator lies at least partly between the first and the second current collector.

8. The separator and current collector unit according to claim 7, wherein the first current collector contains copper or nickel.

9. The separator and current collector unit according to claim 7, wherein the second current collector contains aluminum or nickel.

10. A galvanic cell, comprising:
a first electrically negative electrode,
a second electrically positive electrode; and
a separator and current collector unit, arranged between the two electrodes and in contact with each of them and is provided with an electrolyte.

11. The galvanic cell according claim 10, wherein the galvanic cell is a lithium ion cell.

12. The galvanic cell according to claim 10, wherein the separator and current collector unit has:
N≥2 electrically conductive current collectors;
a first and a second separate current collector,
the first and the second current collector are arranged on the separator such that the separator lies at least partly between the first and the second current collector, and the first current collector is in contact with the first electrode and the second current collector is in contact with the second electrode, and
wherein the first current collector contains copper or nickel.

13. The galvanic cell according to claim 10, wherein the separator and current collector unit has:
N≥2 electrically conductive current collectors;
a first and a second separate current collector,
the first and the second current collector are arranged on the separator such that the separator lies at least partly between the first and the second current collector, and the first current collector is in contact with the first electrode and the second current collector is in contact with the second electrode, and
wherein the second current collector contains aluminum or nickel.

14. The galvanic cell according to claim 10, wherein at least one of the electrodes is designed as a free-standing electrode (FSE).

15. A battery comprising a cell stack that has a multiplicity of stacked galvanic cells according to claim 10.

16. The battery according to claim 15, wherein the separator and current collector units of the galvanic cells of the cell stack each designed having:
N≥2 electrically conductive current collectors;
a first and a second separate current collector,
the first and the second current collector are arranged on the separator such that the separator lies at least partly between the first and the second current collector; and
inside the cell stack, the separator and current collector units that are consecutive along the stacking direction of said cell stack have an alternating orientation, such that, for immediately consecutive separator and current collector units, the respective order of the arrangement of the current collectors and separators is inverted along the stacking direction.

17. The battery according claim 16, wherein at least one of the electrodes of the battery is designed as an integral electrode, which at the same time functions as an identical electrode of two adjacent cells of the galvanic cells in the cell stack.

18. The battery according to claim 15, wherein the galvanic cells are stacked by way of a Z-fold so as to form the cell stack.
